(19) United States
(12) Patent Application Publication
(10) Pub. No.: US 2006/0054679 A1
(43) Pub. Date: Mar. 16, 2006

(54) Method and system for interactive character gaming

(76) Inventor: Karl Ruping, Cambridge, MA (US)

Correspondence Address: Karl Ruping, 411 Massachusetts Ave., Cambridge, MA, 02139, US

(21) Appl. No.: 10/938,985

(22) Filed: Sep. 10, 2004

(51) Int. Cl. G06F 17/00

(52) U.S. Cl. 235/375

(57) ABSTRACT

Character gaming is enhanced by an interactive character gaming system and method that allows a character on a physical consumer product, such as a gaming card, to be wirelessly incorporated into a gaming device such that the character data and the character attributes can be processed and the character image can be displayed. A wireless communication system allows the gaming device to read a character ID, or a class of character IDs, from one or more tags embedded on the physical consumer product. The ID is associated with a particular character or class of characters represented in a database which is resident in the gaming device or is accessible by the gaming device. The character data can be incorporated into a memory unit, transmitted over a network, or animated on a display device. This further allows the data and image to be modified based on time, experience, gaming actions, or other factors.

### RELATED APPLICATIONS

This application claims the benefit of U.S. Provisional Patent Application No. 60/500,987, filed Sep. 9, 2003.

### FIELD OF INVENTION

The present invention relates to a method and system for interactive character gaming, and more particularly a wireless trading card gaming platform that enables the evolution of characters and their dynamic interaction in a gaming console.

### BACKGROUND

Today character-based games may incorporate a set of characters in a computer system that are associated with and modified by activities occurring within that computer system, which may be networked or not. Actions external to the computer system, such as a user's handling of a set of gaming cards, do not influence the computer-based characters or game unless manually inputted by the user. Similarly, characters appearing on a consumer product or a related physical medium, such as an advertisement, a music CD, or a comic book, are independent of an electronic gaming platform and require some form of user input to bring such static characters into a computer system.

Character-based consumer products, such as gaming cards, are static objects with written information or images printed on the product surface. Game systems using such cards sometimes employ complex rules to increase the excitement of the game or to introduce a mix of skill and chance to the game. These game card systems may include a gaming board or other peripheral items to add an element of skill or chance, or to add to the visual appeal of the game. However, such elements do not intelligently interact with the static game cards themselves, develop a unique set of gaming characteristics, or provide an interface between such cards and a computer system.

With the emergence of faster, cheaper and smaller computational devices, some gaming makers have attempted to embed memory systems and computer processors into gaming cards. A recent invention discloses the use of a recordable medium to store and update data on the card during the course of a game. (Kunimasa U.S. patent application #20020052238) However, the hardware elements necessary to process or update data on the card remain expensive relative to the cost of the card, require a sufficient energy source (such as a battery) that disrupts the form-factor of the card, and require significant computational overhead in the card-embedded processor.

Other gaming makers have incorporated physical coding methods on the card, such as a set of raised bubbles on a section of the card that can be “read into” a gaming device by means of a card reader. One example of this application is Nintendo's e-Reader™ which allows one to scan special “dot codes” on e-Reader trading cards that unlock special features such as mini-games, card statistics and other data. Still others have adopted magnetic strips or bar codes to do the same. However, physical bubbles and bar codes are limited by the eventual physical degradation of the card surface, the ease of counterfeiting the card or retrofitting other cards, the small data storage capacity, and other physical limits to such a system.

In these applications, given the limited data storage ability in particular, it is not possible to save the character image or to update the changing data characteristics of the card as it progresses through a single game, much less to do the same across the lifetime of that card. A further weakness of physical bubbles and magnetic card strips is that both systems require some physical interface or contact between the card and the card reader. A further weakness of bar codes and similar systems is that they require line-of-sight or other visual interface between the card and the card reader.

The current invention overcomes these existing limitations related to character-based consumer products, such as gaming cards, and introduces feasible solutions useful to the card manufacturer and to the user.

### SUMMARY OF THE INVENTION

The current invention is a method and system for interactive character gaming that allows a character on a physical consumer product, such as a gaming card, to be wirelessly incorporated into a gaming device such that the character data and the character attributes can be processed and the character image can be displayed. This further allows the data and image to be modified based on time, experience, gaming actions, or other factors.

A wireless communication system allows the gaming device to read a character ID, or a class of character IDs, from one or more tags embedded on the physical consumer product. The ID is associated with a particular character or class of characters represented in a database which is resident in the gaming device or is accessible by the gaming device. The character data can be incorporated into a memory unit, transmitted over a network, or animated on a display device.

One implementation of the invention is a gaming card platform where the wireless communication system consists of one or more radio frequency identity (RFID) tags embedded in one or more gaming cards. The gaming device consists of, or is in communication with, one or more RFID tag readers, a computational unit, a database of characters and related data, and a display device. A character is identified by the reader from the RFID tag-embedded card and is associated to a set of data in the database. The associated character comprised of its image and some or all the associated data is displayed on the display device. Based on a set of gaming rules, the gaming device can calculate and display the results of a game action involving one or more cards or gaming actions. The gaming device may connect with an external network to access on-line gaming players, to refresh the database, or to update gaming rules.

The primary objective of the present invention is to provide a simple solution to the management, use, and enjoyment of characters on physical consumer products by incorporating a wireless system of minimal physical impact on the consumer product and at a low manufacturing cost. Another object of the invention is to provide interactivity between gaming cards and a gaming device without requiring physical interaction or similar user actions that would interfere with the enjoyment of the consumer product or the related game.

A further object of the invention is to enhance the flexibility and excitement of a game or a product promotion by allowing a character to change and “grow” with time and experience, and to add the ability to extend such flexibility and excitement to a network system. Another object of this invention is to provide users with an opportunity to enjoy a game, promotion, or a duel alone, with a virtual opponent on the gaming device, or with a network opponent.

### BRIEF DESCRIPTION OF THE DRAWINGS

The foregoing discussion will be understood more readily from the following detailed description of the invention, when taken in conjunction with the accompanying drawings, in which:

FIG. 1 is an exemplary diagram illustrating an interactive character gaming system.

FIG. 2a and FIG. 2b are diagrams of a consumer product in the form of a gaming card, with FIG. 2a being the exterior view and FIG. 2b being the structural view.

FIG. 3 is a detailed diagram of a gaming control unit.

FIG. 4 is an example network system connecting a gaming control unit to a network of databases.

FIG. 5 is a general diagram of a possible series of steps in a gaming card method.

### DEFINITIONS

In order to more clearly and concisely point out the subject matter of the claimed invention, the following definitions are provided for specific terms used in the following written description and appended claims.

“Character” as used herein is any person, fictional being, image, item or compilation such as, but not limited to, a sports figure, comic, imaginary monster, a fictional warrior/monster, a spell/potion, or other actual or fictional elements, personalities, or items.

“Character data” as used herein is a set of information associated with a particular character or set of characters that may include, but is not limited to, the image or images of the character, character and gaming attributes, or unique character ID of the character, and additional metadata of the character or other characters related to that character.

“Gaming” as used herein means an activity, a hobby, or a process involving characters for entertainment, promotion, or competition. Such gaming can be played alone, with a computational device, or among two or more players.

“Gaming device” or “character reader device” as used herein means a device that—alone or with other devices—can read and process data related to one or more characters. This may also allow for the display and the manipulation of the character. A gaming device may be a personal computer, a computational unit, a personal digital assistant (PDA), a cellular telephone, or a similar device.

“Physical consumer product” or a “physical host” as used herein is a product or item that incorporates, displays, or is associated with a character. This may be, but are not limited to gaming cards, music CDs, or food products, or the packaging of a such consumer products. This may also extend to an advertisement, such as one would find in a magazine or an advertising flier.

“Character tag” as used herein is any form of tag, item, or element that can actively or passively identify a character through a wireless interface or otherwise, having an ID tag data structure.

“ID Tag data structure” as used herein is a set of data on the ID Tag that can be accessed by an ID Tag reader, that data indicating a particular character or a set of characters. Other data may also be resident in the ID Tag Data Structure which may provide other information such as a manufacturing code or security code.

“Character ID” as used herein is the alphanumeric code or similar indication that identifies a particular character of sets of characters.

### DETAILED DESCRIPTION

The present invention provides a method and system for interactive character gaming. The invention allows a character on a physical consumer product to be wirelessly incorporated into a gaming device such that the character data can be processed and the character attributes can be displayed. This further allows the character data and attributes to be modified based on time, experience or other factors. The current invention is useful in providing an interactive character-based platform that makes the once static consumer product more dynamic and thus more appealing.

A character appears on, or is otherwise associated with, a physical consumer product, such as but not limited to an advertisement, product packaging, a comic book, a music compact disk, or a collectable game card. A character ID tag or tags are embedded in or on the physical consumer product, and is capable of wirelessly transmitting data to an ID tag reader. Such reader is capable of transmitting the ID tag data to a gaming device for processing. The ID tag data is associated with a particular character or set of characters represented in a database which is resident in the gaming device or is accessible by the gaming device. A set of characters may be characters of the same image or a number of characters in a category of character types.

A gaming device is in communication with a database of characters with associated information such as character images, properties, and attributes. The gaming device matches the ID tag with a character data set on the database. In another embodiment, the matching of a character ID with a character data set is performed on a computational device that is in communication with the gaming device, and is then transmitted to the gaming device. Such character data set may consist of the character image, sound, attributes and other data that can be displayed or used by a display device, or other devices. This allows for the ID tag data structure to be merely a character ID and possibly additional metadata of reasonable size, leaving the “heavy” image data and other data, some of which may be dynamic, to the database. All or part of such database may be resident internally to the gaming device, accessible over a network, or in a peripheral memory unit such as a memory stick.

The gaming device can update the character data set on the resident database, peripheral memory unity, or networked database. Such updates may be based on new gaming product updates, user actions, character experience, other characters in existence, or other factors. Such changing data can be cached in a memory unit before updating the database. This method and system does not require significant, if any, change to the data on the ID tag embedded on the physical consumer product, thus reducing computational, transmission, and memory resources on the physical consumer product. In an additional embodiment, data on the ID tag can be dynamic, subject to change across the life of the character.

The ID tag data, database data, and other input data or user actions can be transmitted to a computer program on a computational device or related device. The computer program can process the data, such that the data and character can be applied to gaming rules, displayed on a display device and modified based on gaming experience or other factors.

The gaming device and other peripheral devices, such as the display device or network communication device, may be in a single device or in separate devices. In one embodiment the gaming device is in wireless communication with a network access point, such as a cellular telephone, a laptop, or PDA that has access to a network. Thus, the hardware dedicated to gaming (i.e. the gaming device) can be interfaced with the hardware dedicated to network communication (i.e. the cellular telephone).

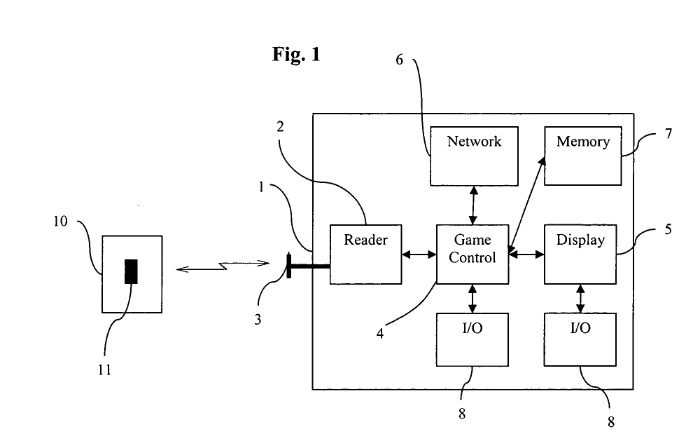

In the preferred embodiment of the invention, the character is a gaming character and the physical consumer product is a gaming card. FIG. 1 demonstrates one implementation of the invention as a card game utilizing an RFID wireless transmission infrastructure enabling communication between a gaming device 1 and one or more gaming cards 10 with embedded RFID tags 11.

An RFID reader 2 stimulates one or more RFID tags 11 on one or more playing cards 10. An RFID tag 11 so stimulated broadcasts its ID tag data structure that is resident in the RFID tag 11. This data is read by the RFID reader 2, which transmits such data and any other relevant data or information to the gaming device 1. The gaming device 1 processes such data, and matches one or more character IDs with character data on a database in a memory unit 7. The gaming device 1 can display the relevant character's image and other data on the display unit 5, where the user can view the various strength profiles and other attributes of the character. The gaming device can also provide audio sound and display a dynamic image or video of the character or characters in action. The user can interact with the gaming device 1 by means of voice commands, the movement or repositioning of game cards, or some form of computer-user interface such as a keyboard or joystick over one or more I/O units 8. Other gaming devices, or other network devices such as a cellular telephone, can also interact with the gaming device in a similar fashion. Network connectivity over a network interface 6 to a refreshed database or on-line players further enhances the character information and the gaming excitement. This connectivity may be directly to the network, such as the internet, or indirectly over a networked device such as a cellular telephone, laptop, or PDA.

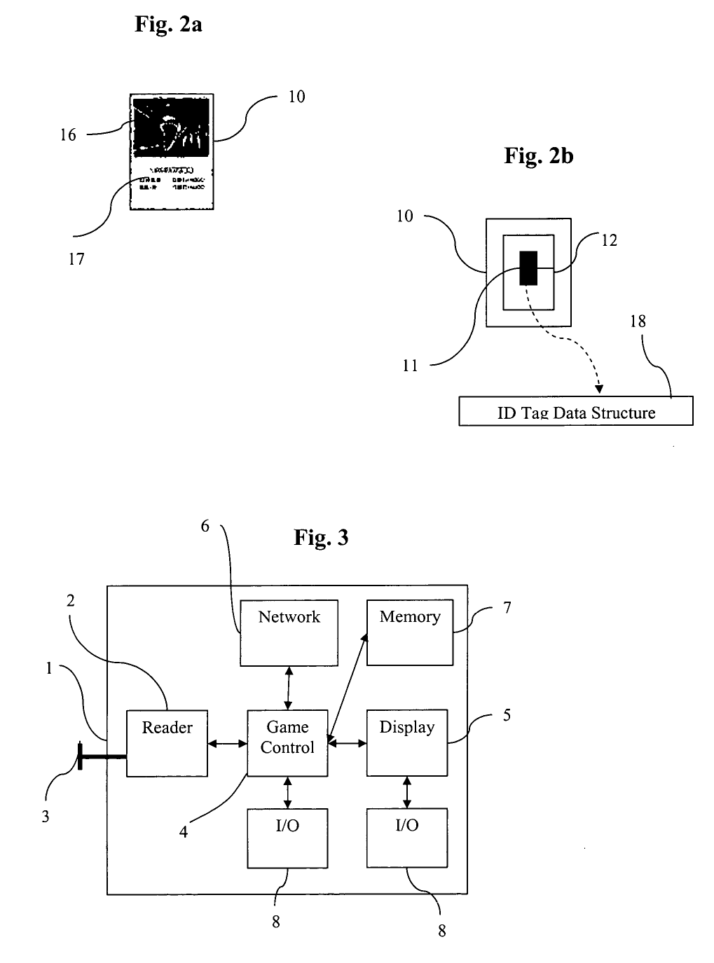

FIG. 2a and FIG. 2b displays a possible implementation of a physical consumer product. In this implementation the physical consumer product is a gaming card 10 that has on its surface associated information of that character, such as an image of the character or the strength and power of the card. In FIG. 2a there is represented the exterior view, consisting of a section of the gaming card 10 that contains an image of a character 16 and a section that contains various character data 17. In FIG. 2b there is represented the structural view of a gaming card 10. Within the card is an RFID-tag 11 with a loop antenna 12 capable of being stimulated by an RFID reader and then broadcasting particular data to such an RFID reader. One of ordinary skill in the art will recognize the possibility of using other wireless communication technologies, as well as the general features of an active or passive RFID system or other system to enable the transmission of data from the gaming card 10 to the gaming device 1.

The RFID tag 11 contains an ID tag data structure 18 of attributive character information. In one implementation the ID tag data structure contains a unique character ID associated with the particular character and the particular playing card 10. The ID tag data structure 18 information can also be unique to a set or subset of cards, such as the set of cards all having the same character or having the same character attributes. On any one card there can be multiple ID tags or one ID tag may contain data on more than one character.

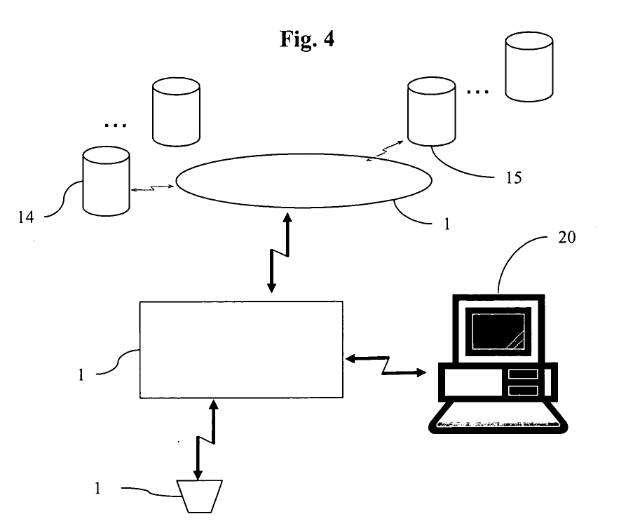

FIG. 3 is a diagram of one implementation of the gaming device 1. An RFID reader 2 and RFID reader antenna 3 may be incorporated into the gaming device 1 or may be independent but in communication with the gaming device 1. The game control unit 4 receives the card ID tag data structure 18 and may also obtain any other relevant data or information from other gaming-related data sources through the RFID reader 2 or other peripherals. Such other peripherals may be a game-enabled personal computer, a gaming board, a wireless access point having on-line gaming data, or a hardware unit. Such data can also be transmitted over the I/O units 8. In one implementation a game control unit 4 has the gaming rules and determines the procedure of the game based on a sequence of input signals from the I/O units 8, enabling input devices such as a keyboard or mouse, or a sequence of actions from the placement of one or more gaming cards in the RFID reader range.

In one embodiment, the gaming rules and attribution information of the particular character or other characters read into the game controller are stored in a memory unit 7. A further implementation, outlined in FIG. 4, allows for such information to be available through a network interface 6 to a network of servers or other databases, or through an I/O unit 8 to a transaction device such as a POS cash register at a card game shop or a memory device such as a memory stick. Network interface 6 and I/O unit 8 connectivity allows for updating of gaming rules, character data, and other attribute information of a character or a set of characters. This may also enable the relationship between a character and a particular user or set of users. Connectivity also allows for the transmission of certain information to a merchant or a game provider. This may include the set of characters held by a particular user or a set of user actions.

Control unit 4 manages the gaming procedure based on the stored gaming rules and RFID-tag data 18. The incorporation of a card-based character into the game can be determined by the placement of cards into a particular field of play, associated with the range or desired range of the RFID reader. Incorporation can also be based on a player action such as a voice command or a queue given over the I/O unit 8 through a peripheral device such as a mouse or keyboard.

Interaction with users can be processed by the gaming device through the game control I/O units 8. One implementation may enable a user to call out in an audible fashion a particular command or identification, such that the gaming device can associate the placing of a card with that command or that user. Game attributed information such as character information, motion-enhanced information, or 3D information which relate to a game procedure or action can be displayed on display unit 5. Such display unit 5 can also send display data to a peripheral device, such as an audio system, through an I/O unit 8.

FIG. 4 illustrates a possible network system that extends the gaming environment beyond the gaming card and gaming device 1. A network interface enables interconnection with outside network infrastructure that enhances gaming applications and reduces the memory capacity needs of the gaming device 1. Access may be through a direct connection or through a network infrastructure 13 such as the Internet. One or more character servers 14 maintain the relationship between character IDs and character data. The character server 14 may maintain dynamic data, new characters introduced into the gaming environment, and changing game rules. Dynamic data may include, for example, the strength of a particular character or set of characters. A query to the character server 14 will provide one or several sets of character data and possibly new updates or refreshed data on particular attributes or game rules. Similarly, the gaming device my provide the character server 14 with revised character data, such as a change in strength. The character server can also maintain the set of characters associated with a particular user or set of users. Such a user may be identified by a unique ID or password that can allow the user to access his or her set of characters.

In one embodiment the network system may include one or more merchant servers 15 that maintain the distribution of RFID-tagged gaming cards 10 through merchants, maintaining consistency among distributed RFID-tagged gaming cards in a gaming device memory, even when the gaming device is not connected to a character server. Newly released gaming cards distributed through merchants are managed and maintained by merchant servers 15, which may be a merchant POS system, to maintain consistency of characters in a game. Users may also update game attributive information through merchant servers 15 at retail merchants through a direct connection to the merchant's POS system, or through a network infrastructure 13 such as the Internet. Data can also be obtained or saved on a memory device 19, such as a memory stick, which can be presented to the gaming device through an I/O unit.

Across the network system, card information may include universal information that is necessary to regulate the gaming procedure or rules, and mechanisms to distinguish each gaming card, or to provide data security, with or without data compression methodology or their equivalents.

One embodiment of the invention is for a class of game cards commonly referred to as dueling card game applications, such as Pokemon or Yu-Gi-Oh. The invention can be applied to other trading card industries, such as sports cards or movie cards, to turn simple collector's items into interactive gaming cards.

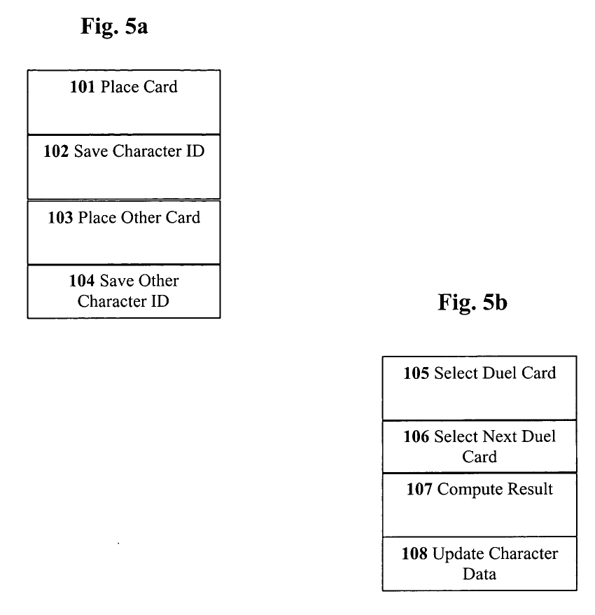

FIG. 5a and FIG. 5b illustrate implementations of a gaming method. In the first set of steps, outlined in FIG. 5a, the player or players register or upload the characters into the gaming device. The steps of FIG. 5a can be performed once, periodically to update the player's registration, or in real-time at each step of the game. In other implementations, FIG. 5a steps are skipped and each character is uploaded into the gaming device during the second set of steps.

In the FIG. 5a set of steps the cards are registered in preparation of a card duel or other actions. FIG. 5b illustrates a series of steps in this card duel. The first player, Player A, places one or more playing cards into the active field of an RFID reader to activate Player A's characters in the gaming device 101. The character ID and other information of Player A's playing cards is processed or stored in the gaming device 102. If there is more than one player, other players, such as Player B, place one or more playing cards into the active field of an RFID reader to activate their characters in the gaming device 103. If there is more than one player, the cards of other players, such as Player B, are processed or stored in the card reader 104. In another embodiment of the method, players can download their individual card ID information through a network or a memory device. In another embodiment of the method, multiple players can perform their FIG. 5a registration on their own gaming device, for eventual FIG. 5b duel using multiple gaming devices. In yet another embodiment of the method, an audible command from a player can enable the gaming device to associate one or more playing cards with the particular player, either prior to gaming or during the duel.

In the second set of steps, FIG. 5b, the player or players participate in a duel. Player A brings characters into the duel by selecting and introducing one or more cards into the duel 105. Similar to FIG. 5a registration 101, this introduction can be by means of bringing the card or cards into the active field of the RFID reader. In a different implementation, this may be by means of activating the selected cards on the reader itself or by other means of activation such as voice commands or on a gaming table. If there is more than one player, other players, such as Player B, bring characters into the dual game by selecting and introducing one or more cards into the duel 106. Similar to FIG. 5a registration 101, this introduction can be by means of bringing the card or cards into the active field of the RFID reader. In a different implementation, this may be by means of activating the selected cards on the reader itself or by other means of activation such as voice commands. In another embodiment of the method, multiple players can perform their FIG. 5b duel on their own gaming device.

The respective characters involved in the duel may be displayed on the gaming device as they are brought into the duel or during the duel itself. The gaming device determines the result of the duel based on gaming rules and the character attributes, and displays the result 107. The character data of the relevant characters is updated to reflect the result of the duel, player actions, and other factors 108. The game may continue with subsequent duel rounds, which may include the cumulative results of prior characters and prior results. Elements of chance can also be introduced by the gaming device.

Additional complexity of the above method is supported by the sequence of dueling characters and card placement. For example, playing a special strength card following a particular character card may impact the current duel. Also, specialty characters could resurrect earlier duel sequences and alter the duel or game results. Such a method allows for new gaming scenarios and supports more dynamic gaming rules. When a single player is in a duel, the gaming device may simulate a competing player with a sequence of cards or characters that are pre-selected or randomly selected by the gaming device or by a player.

The game actions and results can also be stored in memory in a resident memory unit or over a network. This also allows users to resume a game or compare statistics with other players.

The modification of character content can be broadly defined to include visual and non-visual data. The character profile may change with time and with other consumer product updates. For example, a cartoon character with audible phrases is wirelessly transmitted to the gaming device and such phrases may be updated with new phrases with updates or with user modification.

The physical consumer product can be broadly defined to include various products where the characters involved are actual or fictional characters. In the case of a CD music package, the character may be the singer or the group of performers. While the ID tag on the physical product remains the same, the data on a database referenced by that ID tag may change. A biography of the artist or artists can be updated as can the introduction of a new music video or other related consumable products. For a sporting character, such as on a baseball card, the data updated may be based on recent sporting performances.

Although the present invention has been described in terms of various embodiments, it is not intended that the invention be limited to these embodiments. Modification within the spirit of the invention will be apparent to those skilled in the art. Embodiments of the invention can be applied in many situations where geographically separated devices within reasonable proximity are interconnected using a communication medium. Embodiments of the invention can be applied in many situations where some extension to our technology to maybe such cards at personal ID cards. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A character host for use in interactive character gaming comprising:
a host substrate;
a character tag connected to the host substrate, the character tag capable of wireless transmission;
a character ID resident in the character tag;
said character host capable of wirelessly transmitting the character ID.

2. The character host of claim 1 wherein the host substrate is a consumer product.

3. The character host of claim 1 wherein the host substrate is a gaming card.

4. The character host of claim 1 wherein the host substrate is an advertisement medium.

5. The character host of claim 1 wherein the character tag is a radio frequency identity tag.

6. The character host of claim 1 wherein the host substrate has a surface and a body, and the character tag is attached to the host substrate surface.

7. The character host of claim 1 wherein the host substrate has a surface and a body, and the character tag is embedded in the host substrate body.

8. The character host of claim 1 wherein the character ID consists of a unique identifier of one or more characters.

9. The character host of claim 1 wherein the character ID can be modified by an external device in wireless communication with the character tag.

10. The character host of claim 1 wherein the character ID includes character attributive data of one or more characters.

11. The character host of claim 10 wherein the attributive data can be modified by an external device in wireless communication with the character tag.

12. A Character reader device for use in interactive character gaming comprising:
a tag reader capable of wirelessly reading a character ID from a character tag;
a control unit in communication with the tag reader;
a memory unit in communication with the control unit, the memory unit having data associated with one or more character IDs;
said control unit capable of associating a character ID read by the tag reader with a set of data associated with such character ID in the memory unit.

13. The character reader device of claim 12 wherein the tag reader is a radio frequency identity tag reader.

14. The character reader device of claim 12 wherein the memory device is capable of retaining attributive data of one or more character IDs generated from interaction with one or more characters.

15. The character reader device of claim 12 further comprising a display device in communication with the control unit, the display device capable of displaying data associated with one or more character IDs.

16. The character reader device of claim 12 further comprising gaming rules resident in the memory device which can be used by the control unit to process data associated with character gaming.

17. The character reader device of claim 12 further comprising an input device in communication with the control unit, capable of inputting data from an external source.

18. The character reader device of claim 17 wherein the external data consists of human commands.

19. The character reader device of claim 12 further comprising a database in communication with the control unit having a set of data associated with one or more character IDs.

20. The character reader device of claim 19 wherein the database is in communication over a network system

21. An interactive character gaming system comprising:
a host substrate;
a character tag connected to the host substrate;
a character ID resident in the character tag;
a tag reader in wireless communication with the character tag;
a control unit in communication with the tag reader;
a memory unit in communication with the control unit, the memory unit having data associated with one or more character IDs;
said control unit capable of associating a character ID, read by the tag reader from the character tag, with a set of data associated with such character ID in the memory unit.

22. The interactive character gaming system of claim 21 wherein the host substrate is a consumer product.

23. The interactive character gaming system of claim 21 wherein the host substrate is a gaming card.

24. The interactive character gaming system of claim 21 wherein the host substrate is an advertisement medium.

25. The interactive character gaming system of claim 21 wherein the character tag is a radio frequency identity tag.

26. The interactive character gaming system of claim 21 wherein the host substrate has a surface and a body, and the character tag is attached to the host substrate surface

27. The interactive character gaming system of claim 21 wherein the host substrate has a surface and a body, and the character tag is embedded in the host substrate body.

28. The interactive character gaming system of claim 21 wherein the character ID consists of a unique identifier of one or more characters.

29. The character host of claim 21 wherein the character ID can be modified by an external device in wireless communication with the character tag.

30. The interactive character gaming system of claim 21 wherein the character ID includes character attributive data of one or more characters.

31. The interactive character gaming system of claim 30 wherein the attributive data can be modified by an external device in wireless communication with the character tag.

32. The interactive character gaming system of claim 21 wherein the memory device is capable of retaining attributive data of one or more character IDs generated from interaction with one or more characters.

33. The character reader device of claim 21 further comprising a display device in communication with the control unit, the display device capable of displaying data associated with one or more character IDs.

34. The character reader device of claim 21 further comprising gaming rules resident in the memory device which can be used by the control unit to process data associated with character gaming.

35. The character reader device of claim 21 further comprising an input device in communication with the control unit, capable of inputting data from an external source.

36. The character reader device of claim 21 wherein the external data consists of human commands.

37. The character reader device of claim 12 further comprising a database in communication with the control unit, the database having a set of data associated with one or more character IDs.

38. The character reader device of claim 37 wherein the database is in communication over a network system.

39. A method for character gaming comprising:
reading a character ID from a character tag;
associating the character ID with a set of character attribute data on a database;
displaying said character attribute data on a display device.

40. The method of claim 39 further comprising an initial step of registering a set of character hosts with a gaming device.

41. A method for character gaming duals comprising:
reading two or more character IDs from two or more character tags;
associating two or more character IDs with a set of character attribute data;
processing the relative attributes of the character IDs based on a set of game rules;
displaying the outcome of the character gaming duel on a display device.

42. The method of claim 41 further comprising a final step of updating the set of character attribute data with the results of the gaming duel.
